(19) United States
(12) Patent Application Publication
(10) Pub. No.: US 2005/0249340 A1
(43) Pub. Date: Nov. 10, 2005

(54) Apparatus for viewing faxes

(76) Inventor: Kenneth Carpenter, New Barnet (GB)

Correspondence Address: Galgano & Burke, Suite 35, 300 Rabro Drive, Hauppauge, NY, 11788, US

(21) Appl. No.: 11/124,585

(22) Filed: May 6, 2005

(30) Foreign Application Priority Data
May 8, 2004 (GB) GB 0410279.4

(51) Int. Cl. H04M 11/00

(52) U.S. Cl. 379/100.01; 379/93.24

(57) ABSTRACT

Apparatus comprising a modem 10 and a unit 12. The unit 12 having a screen 32 and control buttons. The unit 12 acts to reroute any faxes going through the modem 10 to a memory store provided within the unit 12 so that faxes are not automatically printed out. The memory may be accessed using buttons provided on the unit 12 resulting in the display of a stored fax on a screen 32 provided on the unit 12. The display of the fax allows a user to decide whether they wish to print, delete or save, in order to view at a later date, the fax by selecting the appropriate button. Hence, any unwanted faxes may be deleted saving paper and expense for the fax machine's owner.

This invention relates to an apparatus for and a method of previewing faxes before they are printed out. The invention is applicable to use within offices and homes to prevent excess printing of unwanted faxes.

In the modern age fax has become an important way for advertisers to access potential customers. This has resulted in many messages received by fax machines in homes and offices being either irrelevant to or unwanted by the fax machine's owner or user. These unwanted messages result in large amounts of waste paper and hence wasted resources.

According to a first aspect of the invention there is provided apparatus for viewing faxes comprising means for receiving a fax, means for storing the fax in an electronic version and means for viewing the electronic version. This provides the advantage that faxes may be viewed before being printed out, allowing unwanted faxes to be deleted thereby reducing the amount of waste paper produced.

Preferably the means for viewing the electronic version is detachable from the means for receiving a fax enabling the user to view the faxes more easily.

Preferably the apparatus also has an input for a code which is required to be entered prior to viewing the fax, allowing faxes stored on the unit to be secure.

Embodiments of the invention will now be described, by way of example, and with reference to the drawings in which:

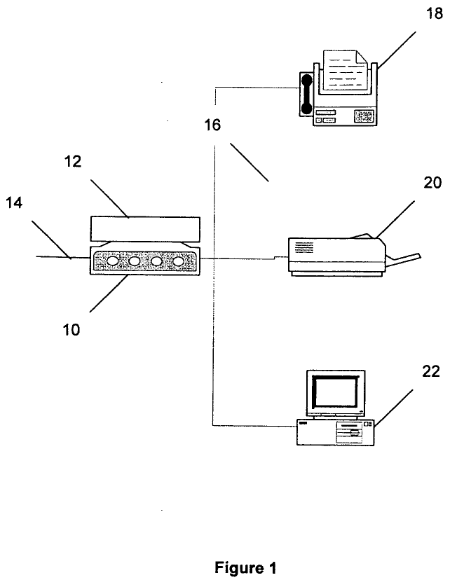

FIG. 1 illustrates connections to and from the apparatus; and

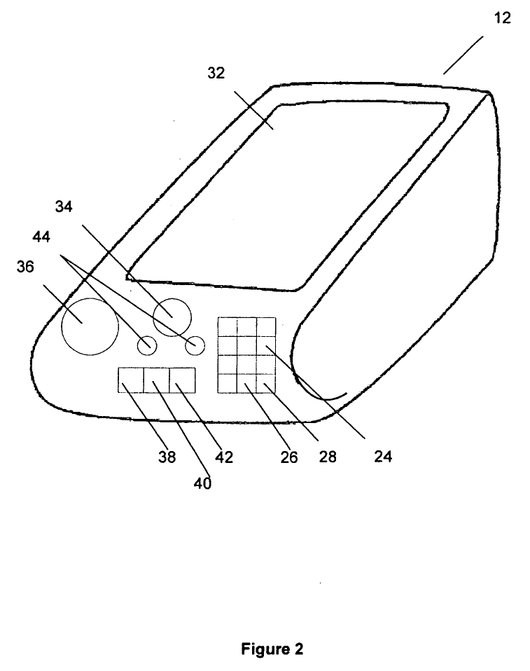

FIG. 2 illustrates a unit.

With reference to FIG. 1, the apparatus consists of a modem 10 having a unit 12 attached to it. The unit 12 may be either permanently attached to the modem 10 or, alternatively, it may be detachable. The unit 12 has a memory for storing a fax in an electronic format, a screen 32 for displaying the stored fax and control buttons. The unit 12 is also provided with connections, which may be either wire or wireless connections, to and from the modem 10.

These connections allow the unit 12 to recognise a fax being sent to a fax machine 18 via the modem 10 and to re-route the fax message to be stored as an electronic version within the unit's memory. Preferably the memory is capable of storing at least 150 pages of A4 sized paper.

The modem 10 contains inputs 14 from a telephone line, for receiving messages, and a mains power supply. The modem 10 also has outputs 16 to at least one of a printer 20, fax machine 18 and computer 22.

With reference to FIG. 2, a user may choose to view a fax using the unit 12. Access to this facility may be limited through the use of an access code. For example, the unit 12 may be provided with control means 24 for entering a code. Preferably the means 24 for entering a code consists of a grid of buttons comprising integer numbers from 0 to 9 on each button of the grid. The code preferably consists of four digits and provides a means for preventing unwanted accessing of messages. This may be of particular use in settings, such as the health service, where confidentiality is important. Extra buttons 26, 28 may also be provided to allow a user means to set a new access code and to switch the access code on and off.

Any stored faxes may be viewed on the unit's screen 32. Preferably, the screen 32 provided on the unit 12 is an LCD screen. For ease of use the unit 12 may be attached to the modem 10 by means of a hinge allowing the screen 32 to be tilted to allow easier viewing.

Alternatively, the hinge may also be arranged to allow the unit 12 to be detached from the modem 10 allowing easier viewing of the contents being displayed on the screen 32. If the unit 12 is detachable from the modem 10 then it may be powered by means of a rechargeable battery which is recharged when the unit 12 is reattached to the modem 10.

Any stored faxes may be viewed by selecting a “view” button (not shown). Once this button is selected the electronic version of the fax is retrieved from the unit's memory and displayed upon the unit's screen 32. Alternatively, faxes may be retrieved from the unit's memory through use of control means 34 provided for navigating a stored fax. These means may be finger-operable input means such as a touch screen, a small touchpad, a joystick-like attachment or buttons for moving left and right and up and down.

Additional buttons may also include an on/off button 36, a “delete” button 38, a “save” button 40, a “print” button 42, buttons 44 for zooming in and out of the fax being displayed on the screen 32 and buttons for setting the access code. Preferably the on/off button 36 is illuminated.

If the user selects the “delete” button 38 the fax being viewed is removed from the unit's memory and is not printed out. If the “save” button 40 is selected then the fax being viewed remains in the memory and is available for further viewing. The fax, however, is not printed. If the “print” button 42 is selected the fax being viewed is printed but not saved to memory.

Users may require selection of alternative options. For example, a user may want to save the fax on the computer 22 rather than in the unit's memory, or the user may want to save a fax and print it out. In this instance selecting the “save” 40 or “print” 42 buttons may bring up a list of options from which the user can select the desired one. Alternatively, the unit 12 may be provided with a “menu” button (not shown) allowing the user to bring up the options list.

Fax machines 18 can also have telephones integral to them. Therefore, the apparatus may be adapted to display the fact that there is an incoming telephone call. It may also be adapted to recognise the differences between the different types of data being received by the modem 10 and thus only store fax messages. This allows other data such as that of telephone calls, to be accessed conventionally.

1. Apparatus for viewing faxes comprising:
means for receiving a fax;
means for storing the fax in an electronic version
an input arranged to receive a code which is required to be entered prior to viewing the fax;
means for viewing the electronic version; and
means for selectively printing the viewed electronic version of the fax.

2. Apparatus for viewing faxes as claimed in claim 1 further comprising an input for connection to the PSTN.

3. Apparatus for viewing faxes as claimed in claim 1 wherein the means for viewing and storing the electronic version are integral to the means for receiving a fax.

4. Apparatus for viewing faxes as claimed in claim 1 further comprising:
means for navigating faxes.

5. Apparatus for viewing faxes as claimed in claim 1 further comprising:
an output couplable to a fax machine.

6. Apparatus for viewing faxes as claimed in claim 1 further comprising:
an output couplable to a printer.

7. Apparatus for viewing faxes comprising:
means for receiving a fax;
means for storing the fax in an electronic version;
means for viewing the electronic version; and
means for selectively printing the viewed electronic version of the fax wherein the means for storing the fax and means for viewing the electronic version are detachable from the means for receiving the fax.

8. A method of viewing faxes comprising the steps of:
receiving a fax;
storing the fax in an electronic version;
viewing the electronic version; and
selecting an electronic version of a fax for printing.
